(19) United States
(12) Patent Application Publication
(10) Pub. No.: US 2010/0033582 A1
(43) Pub. Date: Feb. 11, 2010

(54) METHOD AND APPARATUS FOR CONTROLLING THUMBNAIL DISPLAY AND DIGITAL PHOTOGRAPHING APPARATUS

(75) Inventors: Sook-young Maeng, Suwon-si (KR); Myung-Chun Kim, Suwon-si (KR); San-Joung Cho, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/536,625

(22) Filed: Aug. 6, 2009

(30) Foreign Application Priority Data
Aug. 6, 2008 (KR) 10-2008-0077051

(51) Int. Cl. H04N 5/225

(52) U.S. Cl. 348/207.99; 348/333.01; 348/E05.024

(57) ABSTRACT

Provided are a method and apparatus for transmitting thumbnail images to an external apparatus. The method of controlling a thumbnail display, the method including connecting to an external apparatus; and in response to receiving characteristic information of the external apparatus, transmitting to the external apparatus a number of thumbnail images according to the characteristic information. The method may include providing a menu screen for a user to input the characteristic information. The method may include providing a menu screen for a user to input at least one of: a number of thumbnails to display or a size of thumbnails to display. Transmitting may include transmitting the thumbnail images sized to be inversely proportional to the number of thumbnail images so as to fit a display of the external apparatus.

### CROSS-REFERENCE TO RELATED PATENT APPLICATION

This application claims the benefit of Korean Patent Application No. 10-2008-0077051, filed on Aug. 6, 2008 in the Korean Intellectual Property Office, the entire disclosure of which is incorporated herein by reference.

### BACKGROUND

1. Field of the Invention

The present invention relates to a method and apparatus for controlling a display of thumbnail images, and more particularly, to a method and apparatus for controlling a display of thumbnail images on an external apparatus.

2. Description of the Related Art

Digital photographing apparatuses such as compact digital cameras or digital single-lens reflex cameras (DSLR) are capable of taking and storing many images. Often users want to find a particular image among the many images or want to selectively delete images. However, it can be difficult to review and find images because of the potentially large number of images.

### SUMMARY OF THE INVENTION

Disclosed is a method of controlling a thumbnail display. The method includes: connecting to an external apparatus; in response to receiving characteristic information of the external apparatus, transmitting to the external apparatus a number of thumbnail images according to the characteristic information.

The characteristic information may include at least one of: a screen ratio of the external apparatus and a screen size of the external apparatus.

The method may include providing a menu screen for a user to input the characteristic information.

The method may include providing a menu screen for a user to input at least one of: a number of thumbnails to display or a size of thumbnails to display.

Transmitting may include transmitting to the external apparatus a user selected number of thumbnail images, the thumbnail images sized to be inversely proportional to the number of thumbnail images so as to fit a display of the external apparatus.

Transmitting may include sizing a user selected number of the thumbnail images to fit a display of the external apparatus; and transmitting to the external apparatus the sized thumbnail images.

Transmitting may include determining a number of thumbnail images to transmit based on a predetermined size of the thumbnail images so that the thumbnail images fit on a display of the external apparatus; and transmitting to the external apparatus the determined number of thumbnail images.

In response to receiving characteristic information of the external apparatus may include in response to receiving characteristic information of the external apparatus from the external device, transmitting to the external apparatus a number of thumbnail images according to the characteristic information.

A computer program product is disclosed. The computer program may include a computer-readable medium including a first set of codes for causing a computer to connect to an external apparatus; a second set of codes for causing a computer to transmit to the external apparatus a number of thumbnail images according to the characteristic information, in response to receiving characteristic information of the external apparatus.

An apparatus for controlling a thumbnail display on an external apparatus is disclosed. The apparatus includes an input unit configured to receive selected characteristic information of an external apparatus; a thumbnail generation unit configured to generate thumbnail images from image data; and a control unit configured to transmit a number of the generated thumbnails to the external apparatus according to the characteristic information.

The characteristic information may include at least one of: a screen ratio of the external apparatus and a screen size of the external apparatus.

The control unit may be configured to provide a menu screen for a user to input the characteristic information.

The control unit may be configured to provide a menu screen for a user to input at least one of: a number of thumbnail images or a size of thumbnail images.

The control may be configured to transmit to the external apparatus a user selected number of thumbnail images, the thumbnail images sized to be inversely proportional to the number of thumbnail images so as to fit a display of the external apparatus.

The control unit may be configured to size a user selected number of the thumbnail images to fit a display of the external apparatus; and transmit to the external apparatus the sized thumbnail images.

The control unit may be configured to determine a number of thumbnail images to transmit based on a predetermined size of the thumbnail images so that the thumbnail images fit on a display of the external apparatus; and transmit to the external apparatus the determined number of thumbnail images.

A digital photographing apparatus in which image data is generated by photographing a subject, the image data is stored in thumbnails, and the thumbnails are displayed on a display of a selected external apparatus is disclosed. The digital photographing apparatus includes an input unit receiving from a user specific information comprising at least one piece of characteristic information selected from a screen ratio of the external apparatus and a screen size of the external apparatus; and a control unit determining the number of thumbnails according to the characteristic information transferred by the input unit and controlling displaying of the determined number of thumbnails.

### BRIEF DESCRIPTION OF THE DRAWINGS

The above and other features and advantages of the disclosure will become more apparent by describing in detail exemplary embodiments thereof with reference to the attached drawings in which:

FIG. 1 is an example of a schematic block diagram of a digital photographing apparatus according to an embodiment of the disclosure;

FIG. 2 is a block diagram of a digital signal processor illustrated in FIG. 1;

FIG. 3A illustrates an example of thumbnails displayed on a screen according to an embodiment of the disclosure;

FIG. 3B shows an example of a menu screen for inputting characteristic information of an external apparatus;

FIGS. 4A through 4C illustrate examples of various numbers of thumbnails according to an external apparatus according to another embodiment of the disclosure;

FIG. 5 is a flowchart of a method of controlling a thumbnail display according to an embodiment of the disclosure.

### DETAILED DESCRIPTION OF THE INVENTION

Therefore, there is a need in the art for a method, apparatus, and computer readable medium for enabling users to view images captured by a digital photographing apparatus. A method of controlling a thumbnail display includes connecting to an external apparatus; and in response to receiving characteristic information of the external apparatus, transmitting to the external apparatus a number of thumbnail images according to the characteristic information.

Hereinafter, embodiments of the present disclosure will be described in detail with reference to the attached drawings. Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

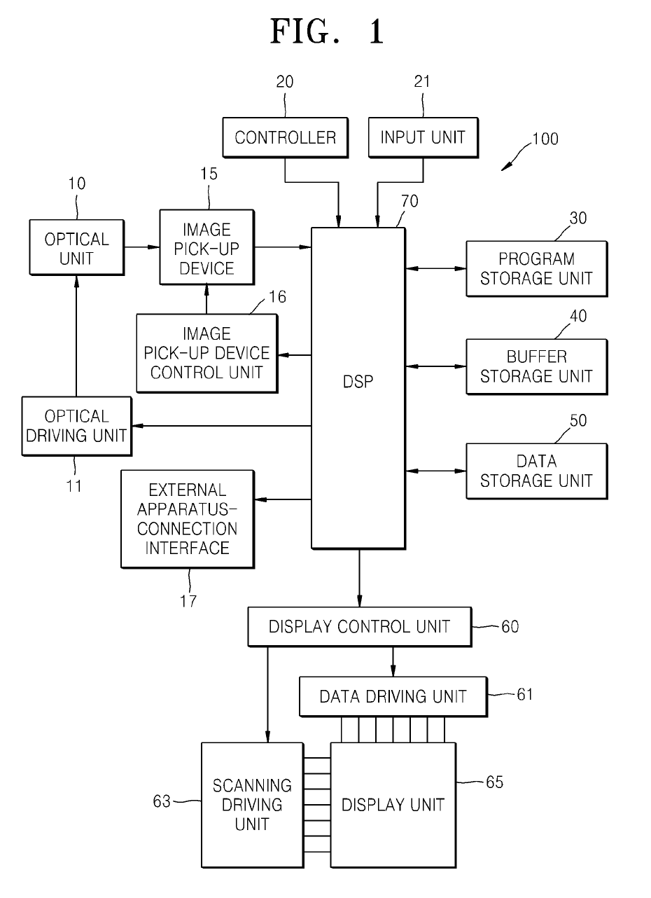

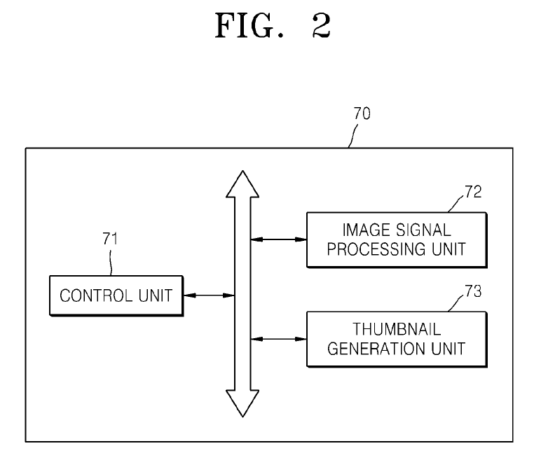

FIG. 1 is a block diagram of a digital camera 100 according to an embodiment of a digital photographing apparatus. FIG. 2 is a block diagram of a digital signal processor (DSP) 70 of the digital camera 100 of FIG. 1.

Referring to FIG. 1, the digital camera 100 includes an optical unit 10, an optical driving unit 11, an image pick-up device 15, an image pick-up device control unit 16, an external apparatus-connection interface 17, a controller 20, a program storage unit 30, a buffer storage unit 40, a data storage unit 50, a display control unit 60, a data driving unit 61, a scanning driving unit 63, a display unit 65, and the DSP 70.

The optical unit 10 receives an optical signal from a subject and provides the optical signal to the image pick-up device 15. The optical unit 10 may include at least one lens selected from a zoom lens for narrowing or widening an angle of view according to a focal length, and a focus lens for focusing on the subject. The optical unit 10 may further include an iris for controlling the amount of light.

The optical driving unit 11 controls a location of the lens and opening or closing of the iris. The optical driving unit 11 may focus on the subject by changing the location of the lens. In addition, the optical driving unit 11 may control the amount of light by opening or closing the iris. The optical driving unit 11 may control the optical unit 10 according to a control signal that is automatically generated when image signals are input in real time or according to a control signal manually input by a user.

The optical signal that has passed through the optical unit 10 reaches a light receiving surface of the image pick-up device 15 and an image of the subject is picked-up. The image pick-up device 15 may be a device that converts an optical signal into an electric signal. Such a device may be a charge coupled device (CCD) or a complementary metal oxide semiconductor image sensor (CIS). Sensitivity of the image pick-up device 15 may be controlled by an image pick-up device control unit 16. The image pick-up device control unit 16 may control the image pick-up device 15 according to the control signal that is automatically generated when image signals are input in real time or according to the control signal manually input by a user.

The external apparatus-connection interface 17 connects the digital camera 100 to an external apparatus, for example, a digital TV, or a personal computer (PC). Herein, the external apparatus-connection interface 17 may include a universal serial bus (USB) or an IEEE 1394 interface, and, in addition to the interface physically connecting the digital camera 100 to the external apparatus, software, such as a connection program, may be included.

In addition, according to an embodiment of the present invention, the external apparatus-connection interface 17 may receive thumbnail data to be displayed on the external apparatus and a control signal for controlling the number of thumbnails, from the DSP 70, and may transmit the thumbnail data and the control signal to the external apparatus.

The user uses the controller 20 to input control signals. The controller 20 may include a shutter-release button for inputting a shutter-release signal to be used to photograph the subject by exposing the image pick-up device 15 to light for a selected period of time, a power source button for supplying power, a wide angle-zoom button or telephoto-zoom button for widening or narrowing the angle of view, a mode selection button for selecting a character-input mode, a photographing mode, or a reproduction mode, and various functional buttons for setting the white balance or degree of exposure. Although, as described above, the controller 20 includes various buttons, the present invention is not limited thereto. For example, the controller 20 may be embodied in any other form through which the user can input control signals, such as a keyboard, a touch pad, a touch screen, or a remote controller.

An input unit 21 receives characteristic information of the external apparatus. Herein, the characteristic information refers to information about a screen ratio or screen size of the external apparatus. For example, when the external apparatus is a digital TV, the screen ratio is 16:9 or 4:3 and the screen size is 21 inches, 42 inches, or 52 inches. Although in the current embodiment the controller 20 is separated from the input unit 21, the function of the input unit 21 may be integrally embodied together with the controller 20.

According to an embodiment of the present invention, the input unit 21 may receive the specific information of the external apparatus described above according a user's selection. However, the input unit 21 can also receive the specific information of the external apparatus from the external apparatus immediately after the digital camera 100 is connected to the external apparatus. In this case, the user may control the number of thumbnails to be displayed on the screen of the external apparatus just by selecting an option included in a screen menu for determining the number of thumbnails according to the external apparatus.

Also, the digital camera 100 includes an operating system (OS) for operating the digital camera 100, the program storage unit 30 for storing a program such as an application program, the buffer storage unit 40 for temporarily storing data that is needed during computing, or result data, and the data storage unit 50 for storing various information needed by the program, such as images files including image signals. In an embodiment of the present invention, image data generated by capturing a specific image and thumbnail data generated together with the image data are stored in the buffer storage unit 40 or the data storage unit 50.

Furthermore, the digital camera 100 includes the display control unit 60 for controlling a display of an operation state of the digital camera 100 or image information generated in the digital camera 100, the data driving unit 61 and scanning driving unit 63 for receiving display data from the display control unit 60 and for transmitting the display data, and the display unit 65 for displaying an image selected according to a signal transferred from the driving unit 61 and the scanning driving unit 63. The display unit 65 may be a liquid crystal display (LCD) panel, an organic light emitting display panel (OLED), or an electrophoresis display panel (EPD).

In addition, the digital camera 100 includes the DSP 70 for processing a transferred image signal and controlling respective units described above according to the image signal or an external input signal.

The DSP 70 will now be described in detail with reference to FIG. 2.

Referring to FIG. 2, the DSP 70 includes a control unit 71, an image signal processing unit 72, and a thumbnail generation unit 73.

The control unit 71 controls the overall operation of the DSP 70. The control unit 71 may receive the specific information about the external apparatus provided by the user though the input unit 21, and determines the number of thumbnails according to the specific information received. That is, the number of thumbnails that is appropriate for the screen ratio or screen size of the external apparatus is determined.

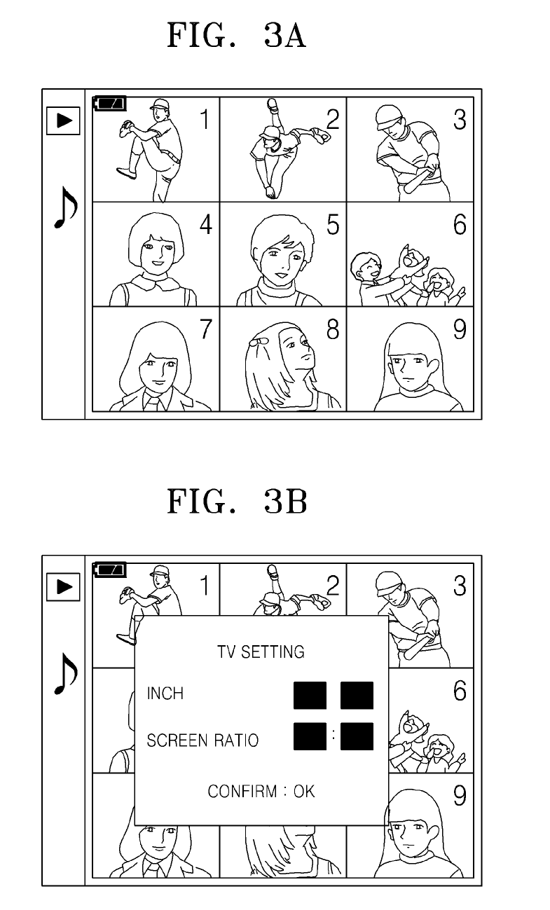

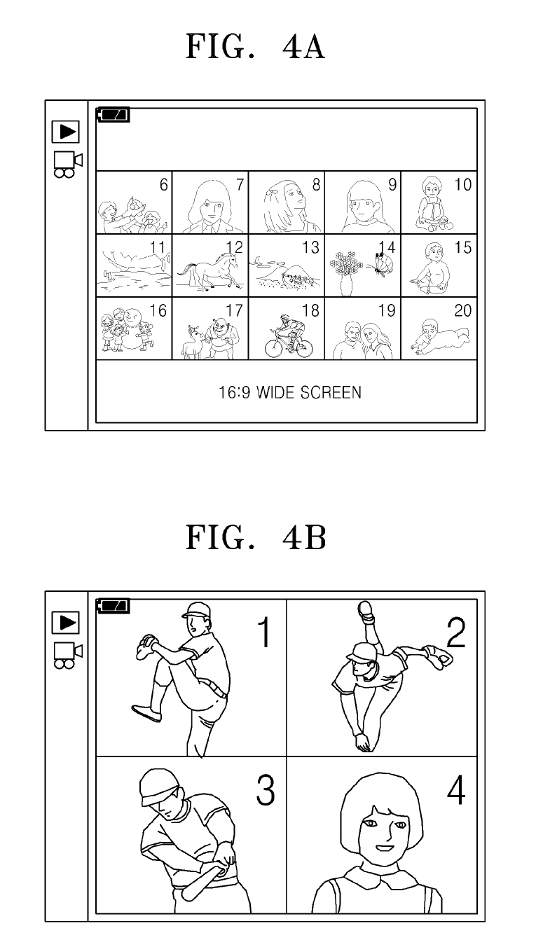

Also, the control unit 71 allows the determined number of thumbnails to be displayed on the screen of the external apparatus. FIG. 3A shows the standard number of thumbnails, that is, nine thumbnails, displayed on a screen of the digital camera 100. When connected to the external apparatus, as illustrated in FIG. 3B, a menu screen for inputting characteristic information about the external apparatus is provided. As illustrated in FIG. 3B, a size in inches and/or a screen ratio may be input as information about the screen size, and the characteristic information may be selected using an up/down key. A left/right key may be used to move among horizontal/vertical selection windows, and set information is automatically renewed by using an OK key.

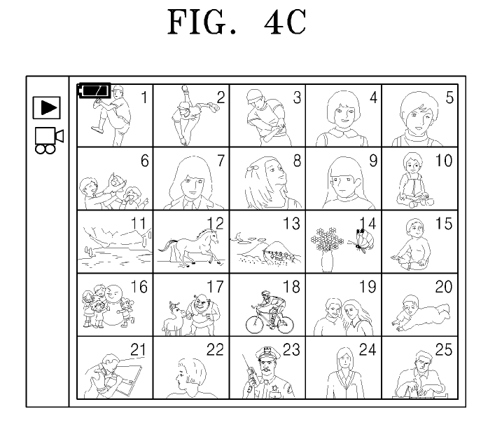

As illustrated in FIGS. 4A through 4C, thumbnails, the number of which is controlled according to the screen size and screen ratio of the external apparatus which are input by the user, are displayed on the screen of the external apparatus. Additionally, the user may specify a number of thumbnails to be displayed on the screen of the external apparatus and the thumb nail generation unit 73 under the control of the control unit 71 will size the thumbnails so that the user specified number of thumbnails will fit on the display of the external apparatus.

FIG. 4A shows 15 thumbnails displayed on an external apparatus having the screen ratio of 16:9, FIG. 4B shows only 4 thumbnails displayed on a 21-inch screen, and FIG. 4C shows 25 thumbnails on a 52-inch screen of an external apparatus.

In addition, when the control unit 71 is connected to the external apparatus, a menu screen that allows the user to determine whether the number of thumbnails is automatically controlled may be provided. However, use of such a menu screen is optional. In addition, the control unit 71 controls the size of thumbnails to be inversely proportional to the number of thumbnails to be displayed. That is, since the size of the screen is limited, as the number of thumbnails increases, the size of respective thumbnails is decreased. On the other hand, as the number of thumbnails decreases, the size of respective thumbnails is increased.

The image signal processing unit 72 converts the image signal transferred by the image pick-up device 15 into a digital signal, and performs an image signal process to convert the image signal to be appropriate for viewing. The image signal processing unit 72 performs the image signal process such as gamma correction, color filter array interpolation, color matrix transformation, color correction, or color enhancement. Also, the image signal processing unit 72 may perform an auto white balance or auto exposure algorithm when the functions of auto white balance and auto exposure are set. Also, the image signal processing unit 72 may control the size of image data using a scalar and compress the image data to form a selected type of image file. The image signal processing unit 72 can also release the compression of the image file. The image signal processing unit 72 may perform the image signal processes on image signals that are input in real time in a live-view mode before photographing and on image signals that are input due to a shutter-release signal. In this case, different image signal processes may be performed on each of the image signals.

The thumbnail generation unit 73 down-samples the captured image data and generates small-size thumbnails. The generated thumbnails may be stored in a memory in the order in which they were captured or in an arrangement order determined by the user. Although in the current embodiment the thumbnail generation unit 73 is separated from the image signal processing unit 72, the image signal processing unit 72 can also integrally perform the function of generating thumbnails.

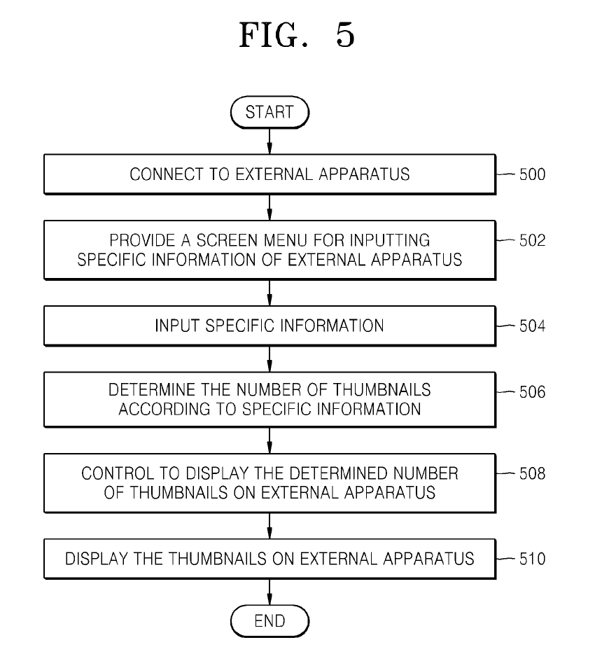

FIG. 5 is a flowchart of a method of controlling a thumbnail display according to an embodiment of the present invention.

Referring to FIG. 5, in Operation 500, a digital camera is connected to an external apparatus via, for example, a USB cable. In this case, immediately after the connection, the number of thumbnails may be automatically controlled or a menu screen for allowing a user to control the number of thumbnails is provided.

In Operation 502, a screen for inputting characteristic information about the external apparatus is provided. Herein, the specific information includes at least one piece of information selected from the screen size of the external apparatus and the screen ratio of the external apparatus. In the current embodiment, the screen size and the screen ratio are described as an example of the specific information, and the specific information is not limited thereto.

In Operation 504, the user inputs the specific information of the external apparatus. Although in the current embodiment it is the user who inputs the specific information of the external apparatus, the specific information of the external apparatus can also be transmitted to the digital camera immediately after the external apparatus is connected.

In Operation 506, the number of thumbnails that are displayable according to the specific information input is determined. In Operations 508 and 510, the determined number of thumbnails are displayed.

According to the embodiments described above, characteristic information about an external apparatus is input and the number of thumbnails is determined according to the specific information, and then the determined number of thumbnails are displayed. Accordingly, users' needs, in terms of various numbers of thumbnails required, can be satisfied.

The present invention can also be embodied as computer readable code on a computer readable recording medium. The computer readable recording medium is a data storage device that can store data which can be thereafter read by a computer system. Examples of the computer readable recording medium include read-only memory (ROM), random-access memory (RAM), CD-ROMs, magnetic tapes, floppy disks, optical data storage devices etc. The computer readable recording medium can also be distributed over network coupled computer systems so that the computer readable code is stored and executed in a distributed fashion.

For convenience, in the description above, the functionality described has been divided into a number of units; however, the number of units may vary and the functionality described above may be differently divided among the units, or the functionality described above may be implemented without units. The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. While the present invention has been particularly shown and described with reference to exemplary embodiments thereof, it will be understood by those of ordinary skill in the art that various changes in form and details may be made therein without departing from the spirit and scope of the present invention as defined by the following claims.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a thumbnail display, the method comprising:
connecting to an external apparatus; and
in response to receiving characteristic information of the external apparatus,
transmitting to the external apparatus a number of thumbnail images according to the characteristic information.

2. The method of claim 1, wherein the characteristic information comprises at least one of: a screen ratio of the external apparatus and a screen size of the external apparatus.

3. The method of claim 1, further comprising:
providing a menu screen for a user to input the characteristic information.

4. The method of claim 1, further comprising:
providing a menu screen for a user to input at least one of: a number of thumbnails to display or a size of thumbnails to display.

5. The method of claim 1, wherein transmitting further comprises:
transmitting to the external apparatus a user selected number of thumbnail images, the thumbnail images sized to be inversely proportional to the number of thumbnail images so as to fit a display of the external apparatus.

6. The method of claim 1, wherein transmitting further comprises:
sizing a user selected number of the thumbnail images to fit a display of the external apparatus;
transmitting to the external apparatus the sized thumbnail images.

7. The method of claim 1, wherein transmitting further comprises:
determining a number of thumbnail images to transmit based on a predetermined size of the thumbnail images so that the thumbnail images fit on a display of the external apparatus;
transmitting to the external apparatus the determined number of thumbnail images.

8. The method of claim 1, wherein in response to receiving characteristic information of the external apparatus, further comprises:
in response to receiving characteristic information of the external apparatus from the external device,
transmitting to the external apparatus a number of thumbnail images according to the characteristic information.

9. A computer program product, comprising:
a computer-readable medium comprising:
a first set of codes for causing a computer to connect to an external apparatus;
a second set of codes for causing a computer to transmit to the external apparatus a number of thumbnail images according to characteristic information of the external apparatus, in response to receiving the characteristic information.

10. An apparatus for controlling a thumbnail display, the apparatus comprising:
an input unit configured to receive selected characteristic information of an external apparatus;
a thumbnail generation unit configured to generate thumbnail images from image data; and
a control unit configured to control the thumbnail generation unit to generate thumbnail images according to the received characteristic information and configured to transmit the generated thumbnails to the external apparatus.

11. The apparatus of claim 10, wherein the characteristic information comprises at least one of: a screen ratio of the external apparatus and a screen size of the external apparatus.

12. The apparatus of claim 10, wherein the control unit is configured to provide a menu screen for a user to input the characteristic information.

13. The apparatus of claim 10, wherein the control unit is configured to provide a menu screen for a user to input at least one of: a number of thumbnail images or a size of thumbnail images.

14. The apparatus of claim 10, wherein the control unit is configured to control the thumbnail generation unit to generate a user selected number of thumbnail images sized to be inversely proportional to the number of thumbnail images so as to fit a display of the external apparatus, and configured to transmit the generated thumbnail images to the external apparatus.

15. The apparatus of claim 10, wherein the control unit is configured to size a user selected number of the thumbnail images to fit a display of the external apparatus; and transmit to the external apparatus the sized thumbnail images.

16. The apparatus of claim 10, wherein the control unit is configured to determine a number of thumbnail images to transmit based on a predetermined size of the thumbnail images so that the thumbnail images fit on a display of the external apparatus; and transmit to the external apparatus the determined number of thumbnail images.

17. A digital photographing apparatus in which image data is generated by photographing a subject, the image data is stored in thumbnails, and the thumbnails are displayed on a display of a selected external apparatus, the digital photographing apparatus comprising:
an input unit receiving from a user specific information comprising at least one piece of characteristic information selected from a screen ratio of the external apparatus and a screen size of the external apparatus; and
a control unit determining the number of thumbnails according to the characteristic information transferred by the input unit and controlling displaying of the determined number of thumbnails.
